(19) United States
(12) Patent Application Publication
(10) Pub. No.: US 2017/0007857 A1
(43) Pub. Date: Jan. 12, 2017

(54) Brake Shoes Mechanism

(71) Applicant: Cong Meng, Valparaiso, IN (US)

(72) Inventor: Cong Meng, Valparaiso, IN (US)

(21) Appl. No.: 15/215,567

(22) Filed: Jul. 20, 2016

(51) Int. Cl. A62B 1/08; A62B 1/18

(52) U.S. Cl. CPC A62B 1/08; A62B 1/18

(57) ABSTRACT

The brake system composes a circular wheel, brake shoes, brake disc and cable reel rotation. The rubbing action between brake shoes and brake disc generating from the rotation of Axle rotating with the planetary gear, which is driven by the cable reel, reduces the falling speed. (Falling speed about 1.7 meters per second) The inner cable is designed with a length of 82 meters and max load of 177 kg. The decelerator of this device could stop the falling immediately by using hand brake, in order to achieve rescue and avoid probable injure.

### TECHNOLOGICAL FIELD

This product is an escaping device, which can be used in emergency threatening people's safety or even life (such as fire, earthquake) that happens on most high-risk buildings, including public or private buildings. Users could escape from the danger by using this device.

### BACKGROUND

The high speed of the urbanization boomed the construction of high-risk buildings and the immigrant of rural population reduced per-capita living space of urban residents with a consequence that the emergence of high-risk buildings slowed down the burst of the living space reduction problem. However, the construction of high-risk buildings is a double-edged sword; it establishes the metropolis but brings danger to residents at the same time. Once the building is in the case of fire, the fire would spread rapidly to all the directions; the smoke would arise disorder among the crowd escaping from stairway so that these people would miss the best opportunity for escaping. Therefore, a self-rescue escaping device especially for residents living in high-risk buildings is necessary.

For users' convenience, this product provides a backpack with the escaping device in it, which makes self-rescue effective.

The design of the breaking system of this product inspires from that of motorcycle. Due to the patent of motorcycle brake system has been widespread, the brake system of this escaping device has been reformed and improved so that it is better at controlling the falling extent or stopping immediately.

This product inspires from US Patent publication No. 2010/181145 and US Patent publication No. 2001/245048. The former patent describes an escaping device consisting of a rotatable hollow spool around a rotating axis and braided steel cable. A centrifugal brake mechanism, including a brake assembly, a pair of brake shoes and brake pads is designed in order to apply a braking force.

The later patent describes a descending device for persons to be rescued from high buildings in emergency. The main components of this device are rope released by a rope container and a suspension strap. Users can achieve self-rescue by using this device with both hands.

This product is built on friction and deceleration principle, which controls the falling speed by reducing the speed of cable avulsed. This device is mainly composed of brake axis, cable reel, steel cable, three planet gears and manual brake. The main parts are brake axis, brake shoes that screws within the cable reel and planet gears that works as differential and transmission. The reel structure is fixed inside the backpack; in use, the combined safety buckle on the top of the cable should be pull out of the backpack and locked on the suspension loop fixed inside the room; the safety buckle on the backpack helps fixing the bag on the back.

### DESCRIPTION OF THE DRAWING

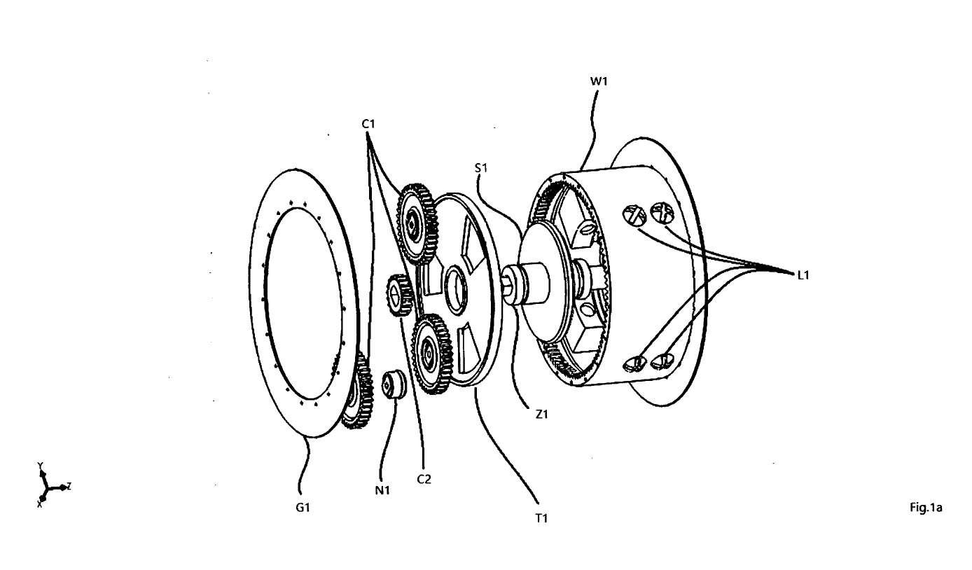

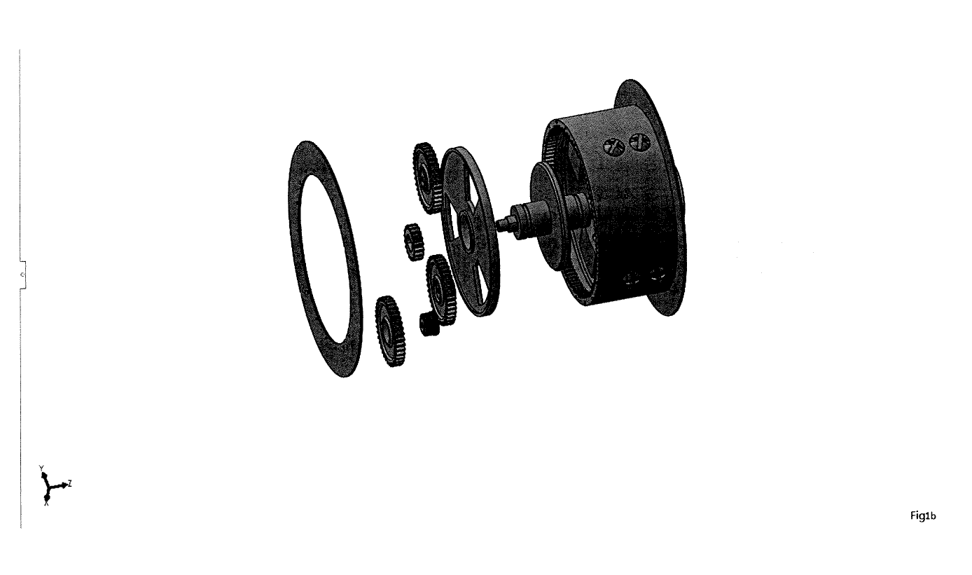

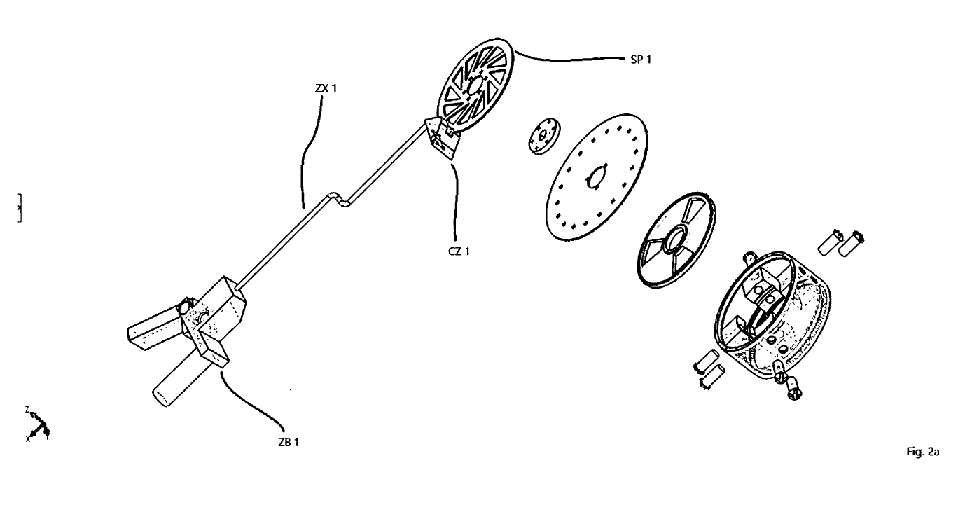

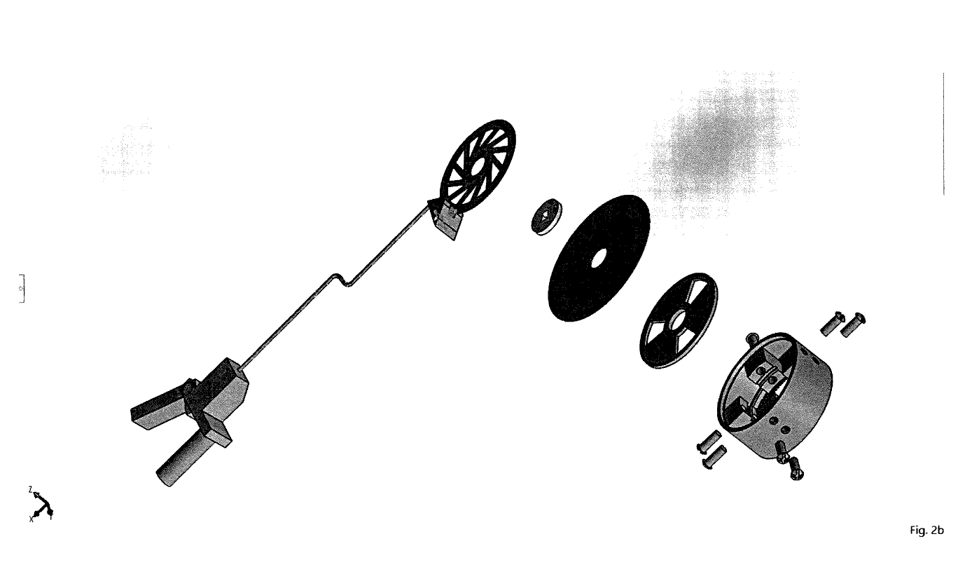

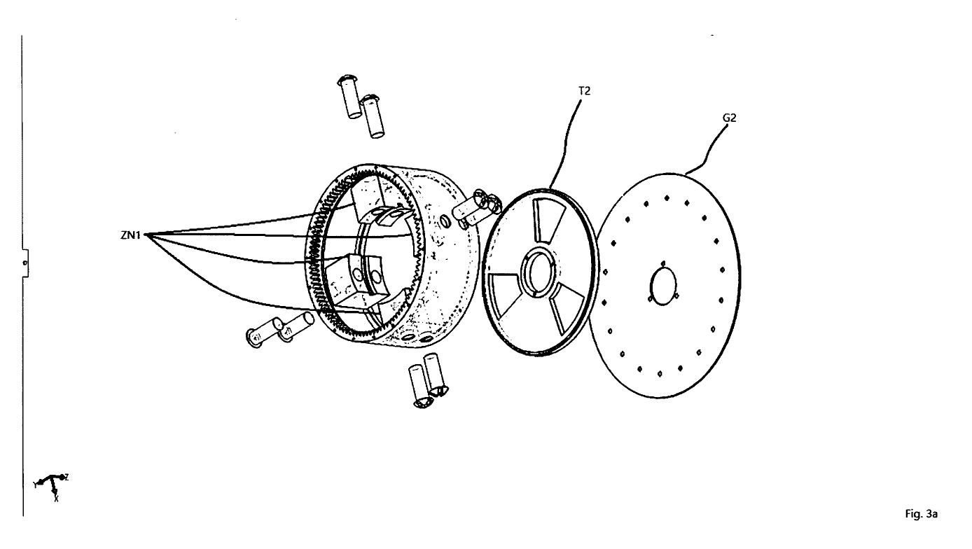

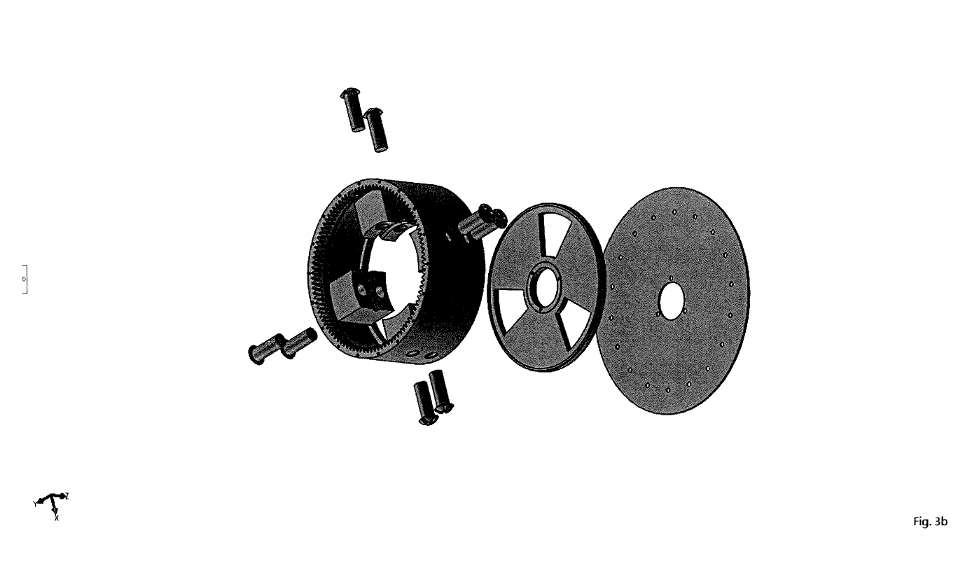

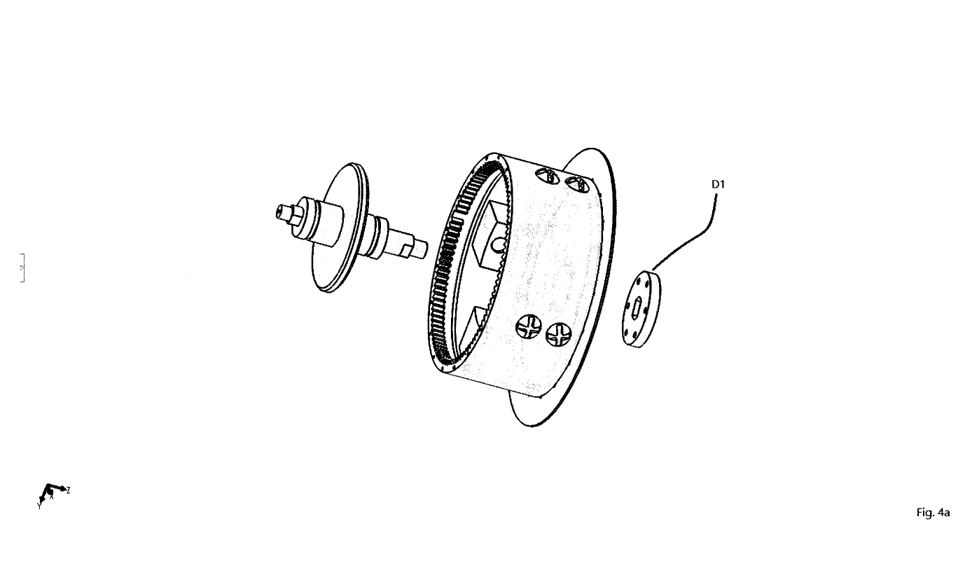

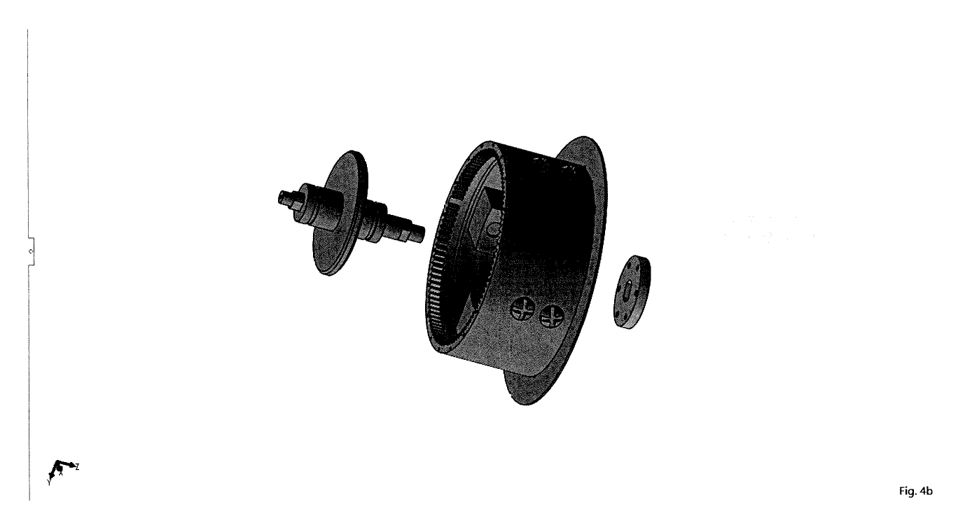

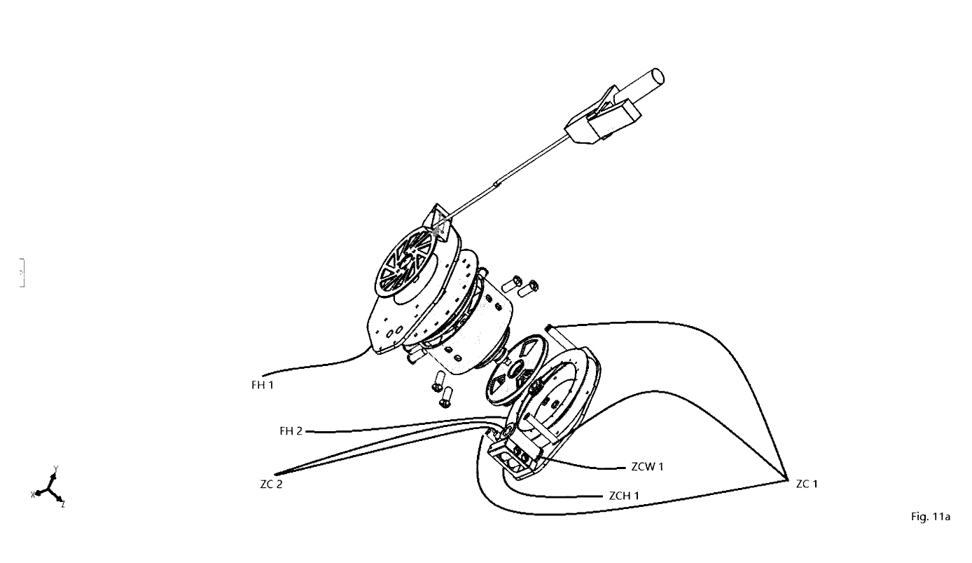

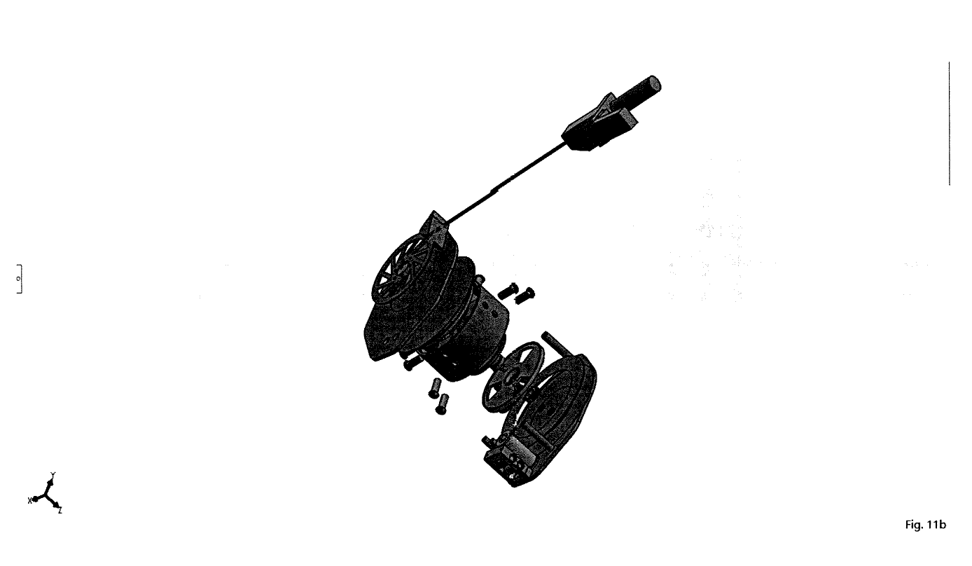

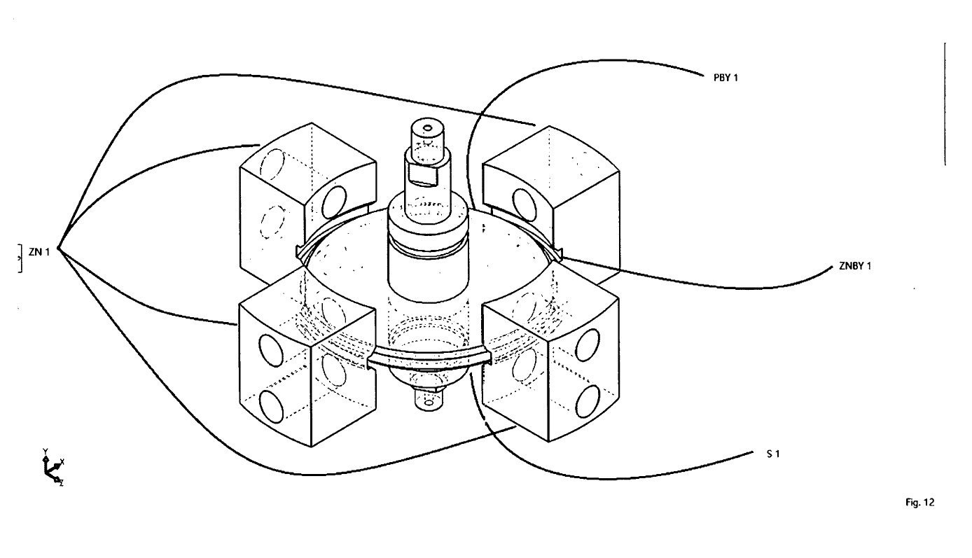

D1 Manual brake connecting plate (FIG. 4a)
G1 Reel flange 1 (FIG. 1a)
G2 Reel flange 2 (FIG. 3a)
C1 Planet-gear (FIG. 1a)
C2 Sun-gear (FIG. 1a)
N1 Bearing of planet gear (FIG. 1a)
W1 Cable reel (FIG. 1a)
L1 Screw fixing brake shoes and cable reel (FIG. 1a)
S1 Brake disc (FIG. 1a and FIG. 12)
Z1 Center cable reel (FIG. 1a)
T1 Planet gear 1 (FIG. 1a)
T2 Planet gear 2 (FIG. 3a)
ZN1 Brake shoes (FIG. 3a and FIG. 12)
SP1 Manual brake disc (FIG. 2a)
ZX1 Manual brake line (FIG. 2a)
ZB 1 Manual brake stick (FIG. 2a)
CZ 1 Manual brake caliper (FIG. 2a)
FH 1 Side cover planet 1 (FIG. 11a)
FH 2 Side cover planet 2 (FIG. 11a)
ZC 2 Support rods 2 (FIG. 11a)
ZCW 1 Roller shaft (FIG. 11a)
ZCH 1 Cable avulsing bearing (FIG. 11a)
ZC 1 Support rods 1 (FIG. 11a)
PBY 1 The edge of brake disc
ZNBY 1 Rut of brake shoes

### DETAILED DESCRIPTION OF EMBODIMENTS

General:
1. The mechanism of this product is that the rubbing action between brake disc (S1) and brake shoes (ZN1) reduces the falling speed to 1.7 meters per second in order that users could ground safely. Four brake shoes (ZN1) are screwed (L1) on the internal wall of the cable reel (W1) as a cross shape. Center cable reel (Z1) brake disc (S1) inlayed among the brake shoes (ZN1) could rotate but the speed of which would reduce due to the frictional resistance by rubbing against the brake shoes (ZN1). The differential generating from the joint rotation of the sun-gear (C2) on the top of the center cable reel (Z1) brake disc (S1) and three planet gears (C1) connected on the top of the cable reel (W1) ensures the deceleration and stability. These three differential planet gears (C1) and the small sun gear (C2) compose a planet differential model, which joins up with the inner ring gear of the cable gear. Due to the cable is avulsed continuously, the cable reel (W1) rotates; and the rotation of planet gears (C1) makes the axis rotate in the opposite way to the cable reel (W1); simultaneously, the break disc (S1) welding with the axis rubs against the brake shoes (ZN1) screwing (L1) within the cable reel (W1); the cable reel (W1) slows down with the deceleration of the cable avulsing so that the falling speed is reduced. In this product, the cable reel (W1) works as a container of all the other mechanical parts; the interior brake system is the part applying for patent. The decelerator of this device could stop the falling immediately in order to achieve rescue and avoid probable injure. The manual brake disc (SP1) and the manual brake connecting plate (D1) are both strung by the center cable reel (Z1); the manual brake disc (SP1) is infibulated in the manual brake caliper (CZ1), which is controlled by the manual brake stick (ZB1) and connected with the brake stick (CZ1) by the brake cable (ZX1). The mechanism of this product inspires from the manual brake system of motorcycle but is reformed and improved; the brake cable (ZX1) is improved and strengthened with special high tenacity material so that it is dependably safe and stable. The cable reel (W1) and the external cover planet (FH) are made of high-density alloy in order to protect the cable (W1) and ensure it avulses as it is designed. The support rods (ZC) work for ensuing the stability of the cover planet (FH), on which a rods-structured cable outlet is designed to make sure the cable could be avulsed fluently. The internal support rods (ZC) are protected by the roller shafts (ZCW1), in order to strengthen the stability out of safety consideration. The combined safety buckle on the top of the cable could effectively avoid breaking away from the cable even it is rubbed, collided and squeezed. The main decelerating device is fixed inside the special backpack with multiple buckles in order to ensure the safety of users. The external of the backpack is made of water-proof nylon, which can protect the device inside the bag and is no harm to persons. The safety buckle on the backpack is made of alloy and with combined design, which can effectively avoid damage and secession when squeezed or dragged and ensure the safety of users. The inner cable is designed with a length of 82 meters and max load of 177 kg.
2. This product works with a suspension loop fixed on the wall inside; once emergency happens, users should lock the combined safety buckle onto the suspension loop, carry the bag on the back, and fasten the buckle on the bag simultaneously.
This product provides two options of the backpack, which are high-intensity metallic cover backpack and water-resistant nylon backpack. Also, in order to avoid the injured caused by falling objects, special protective equipment is provided with this product.

Main System of This Device (The Part Which Use for Apply Patent)

FIG. 12 shows the main brake system. This is the primary system that our company want to apply for patent. This figure shows the brake disc (S1) and brake shoes group (ZN1). Meanwhile this figure shows the combination of those components. The mechanism of this part is that the rubbing action between brake disc (S1) and brake shoes group (ZN1) reduces the rotate speed. The edge of brake disc (PBY1) anastomose with rut of brake shoes (ZNBY1). Those two components can produce friction force, but the brake disc (S1) can still free rotate on the center of brake shoes group (ZN1).

### BRIEF DESCRIPTION OF DRAWINGS

FIG. 1a is the view from the planet-gear side. This figure include planet-gear system and also with brake disc system and brake shoes group. FIG. 1b is the 3D version of FIG. 1a.

FIG. 2a shows the manual brake system. This system connect with the cable reel. Meanwhile, this figure shows the opposite side of FIG. 1a.

FIG. 2b are the 3D version of FIG. 2a.

The view of FIG. 3a is the same side with FIG. 2a but without manual brake system. This figure shows more details. It is easier to review details in this figure because each component stay clearly. FIG. 3b are the 3D version of FIG. 3a.

FIG. 4a is the detailed drawing about brake disc. FIG. 4b is the 3D version of FIG. 4a.

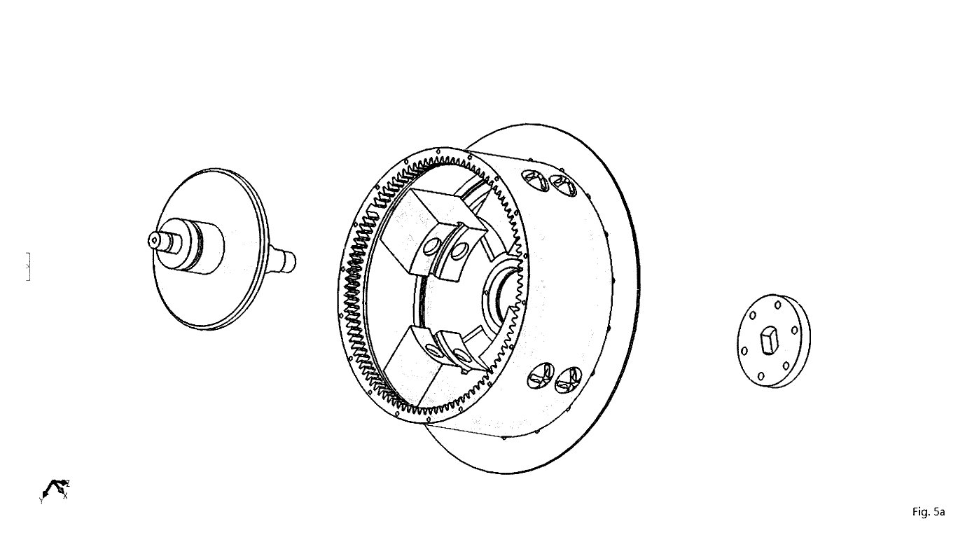

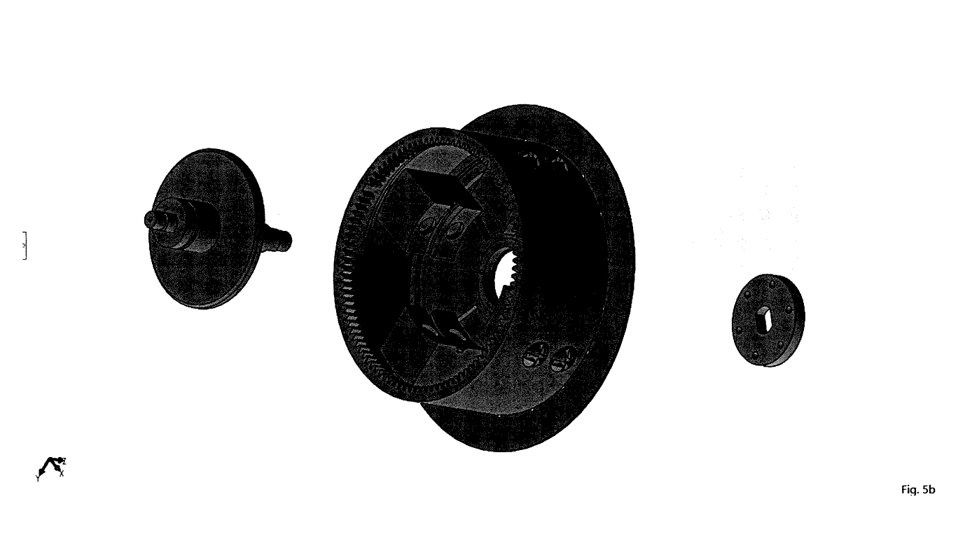

FIG. 5a shows the same components with FIG. 4a but with different viewpoint. This figure shows clearer inner details for the cable reel. FIG. 5b is the 3D version of FIG. 5a.

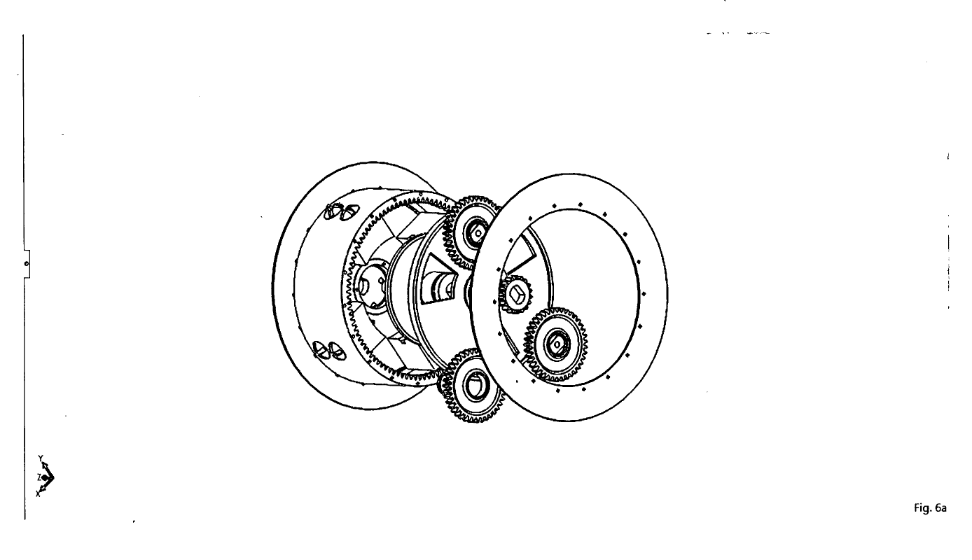

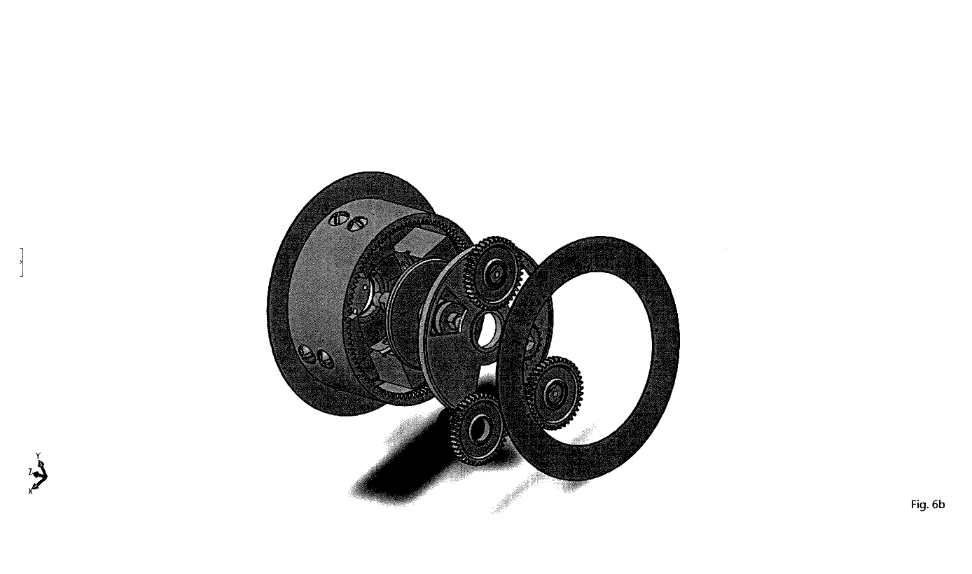

FIG. 6a shows the same components with FIG. 1a but with different viewpoint. This figure shows more detail for the inside of the cable reel.

FIG. 6b is the 3D version of FIG. 6a.

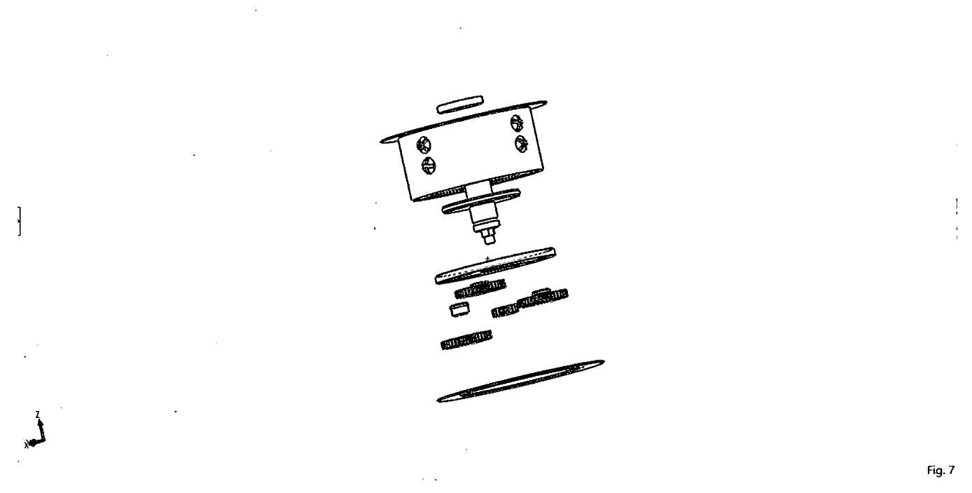

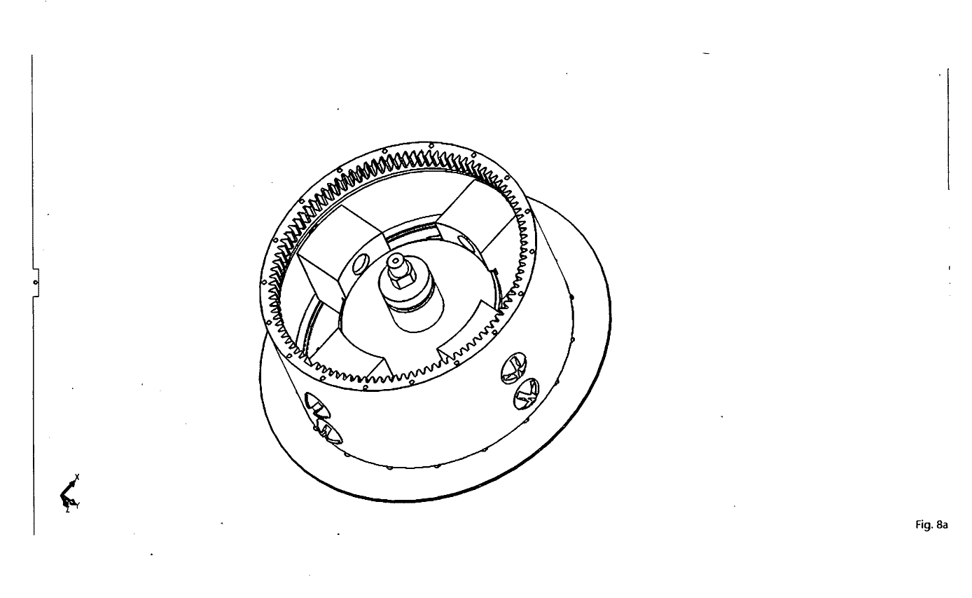

FIG. 7 shows the same components with FIG. 1a but with different viewpoint. This figure shows the sequence of the components that set in the cable reel, and also how they arrange in the cable reel.

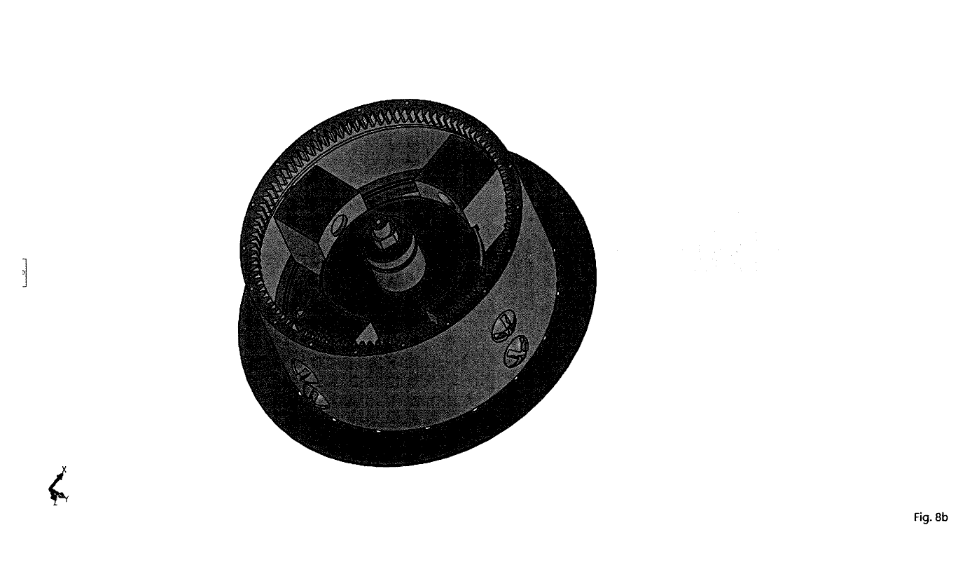

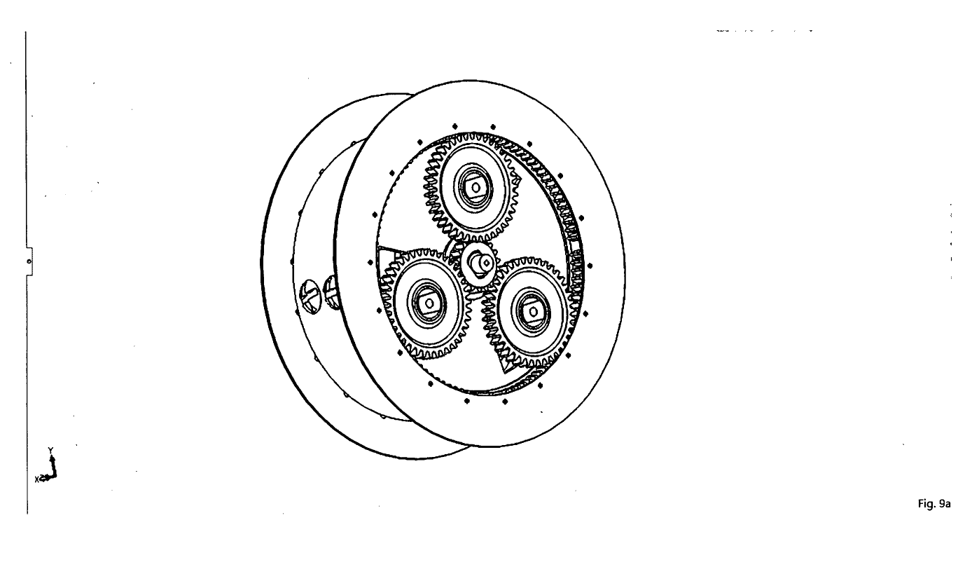

FIG. 8a shows the same components with FIG. 4a. In this figure, it shows how brake disc connect with brake shoes correctly. This figure shows more detail for how that components combination. FIG. 8b is the 3D version of FIG. 8a.

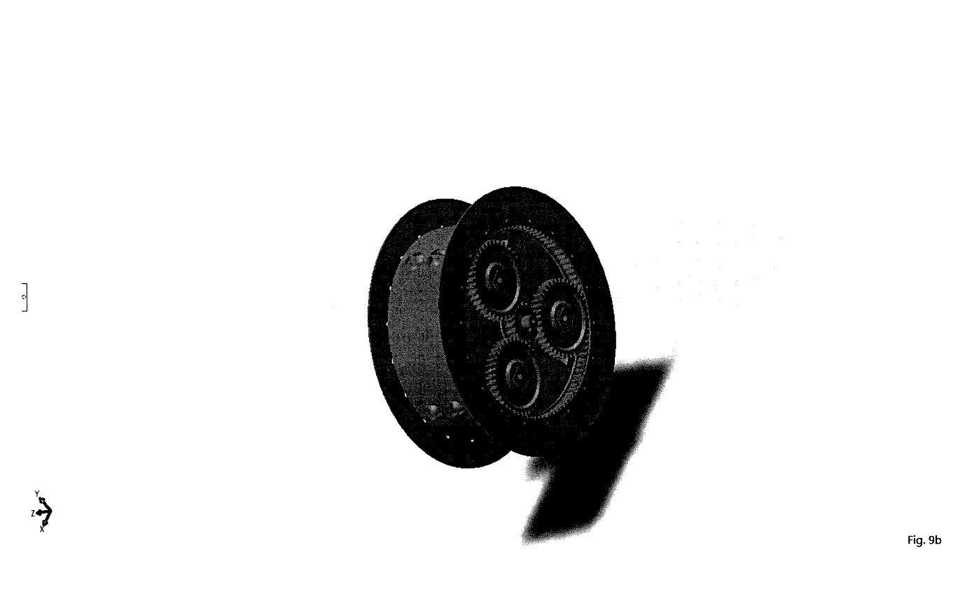

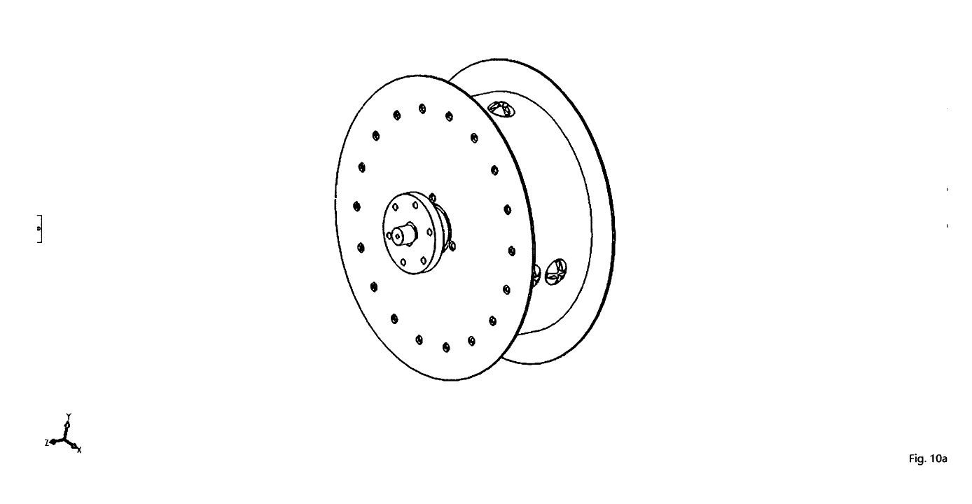

FIG. 9a shows the same components with FIG. 1a but all the components are combined together. This figure shows more detail for that components combination. FIG. 9b is the 3D version of FIG. 9a.

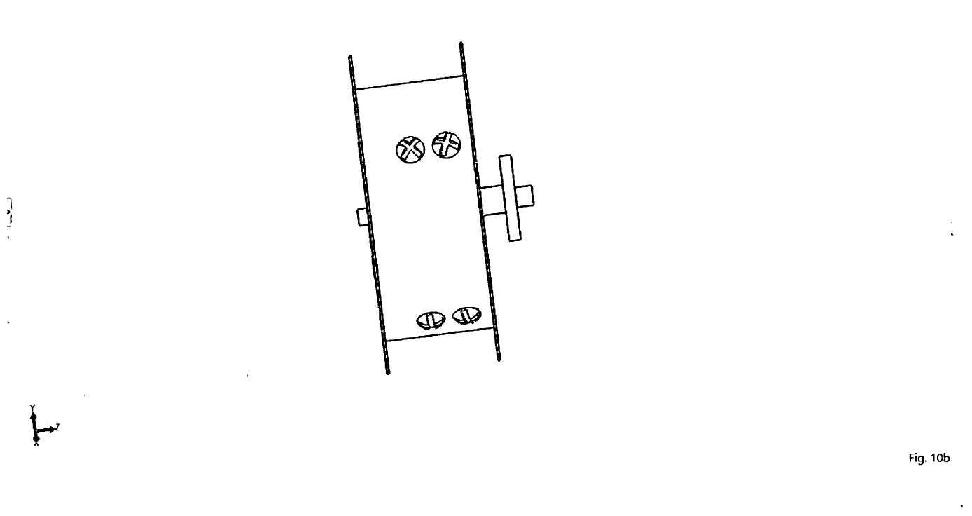

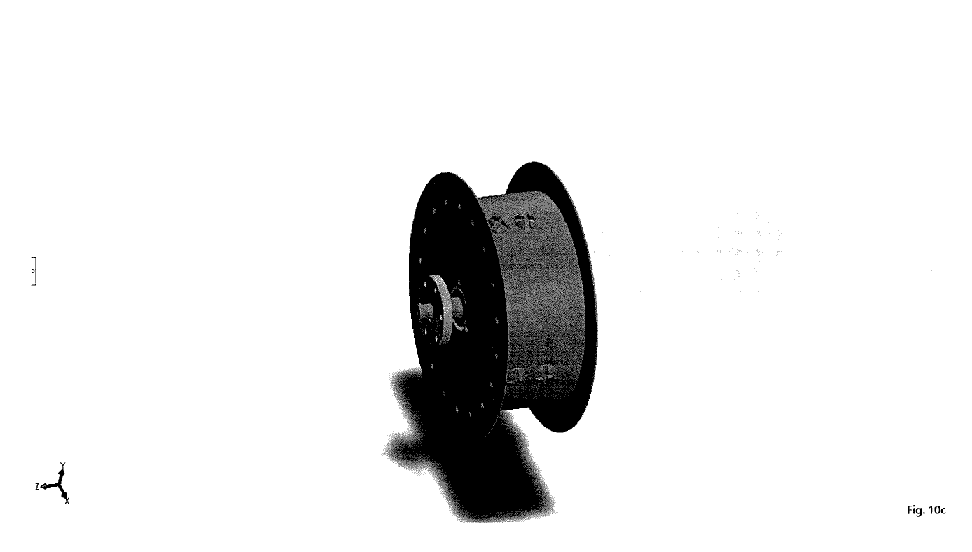

FIG. 10a shows the main system combination together but without manual brake system. This is also opposite side of FIG. 9a. FIG. 10b shows another viewpoint of FIG. 10a. And FIG. 10c is the 3D version of this combination system.

FIG. 11a shows entire system, it includes manual brake and main brake system. This figure also include side cover planet which use to protect main system. This figure shows all the detail of this equipment, this is the most particular figure of all those figures. FIG. 11b is the 3D version of FIG. 11a.

FIG. 12 shows the main brake system. This is the primary system that our company want apply for patent. This figure shows the brake disc and brake shoes group. And this figure also shows how those components combination together.

1. This product is an escaping device for high-rise buildings. The feature of this device is that it is mainly composed of brake axis, cable reel, steel cable, three planet gears and manual brake. The main parts are brake axis, brake shoes that screws within the cable reel and planet gears that works as differential and transmission. The mechanism of this product is that the rubbing action between brake disc and brake shoes reduces the falling speed to 1.7 meters per second in order that users could ground safely. Due to the cable is avulsed continuously, the cable reel rotates; and the rotation of planet gears makes the axis rotate in the opposite way to the cable reel; simultaneously, the brake disc welding with the axis rubs against the brake shoes screwing within the cable reel; the cable reel slows down with the deceleration of the cable avulsing so that the falling speed is reduced. In this product, the cable reel works as a container of all the other mechanical parts; the interior brake system is the part applying for patent. The cable is made by special high tenacity material that works well on ensuring the safety of users. This product works with deceleration device in order to increase rescue possibility and avoid probable injure.

2. According to the claim requirement, the feature of this product is the escaping device works with a suspension loop fixed on the wall inside; once emergency happens, users should lock the combined safety buckle onto the suspension loop, carry the bag on the back, and fasten the buckle on the bag simultaneously.

3. According to the claim requirement, another feature of this product is working with no power; the main mechanism is gravity and friction. Once the emergency happens, users have to escape the high-rise building from windows with this device and use it in a correct way in order to ground safely.

4. According to the claim requirement, another feature of this product is the manual brake system; the manual brake system is infibulated in the manual brake caliper, which is controlled by the manual brake stick and connected with the brake stick by the brake cable. The mechanism of this product inspires from the manual brake system of motorcycle but is reformed and improved.
